(19) United States
(12) Patent Application Publication
(10) Pub. No.: US 2010/0144261 A1
(43) Pub. Date: Jun. 10, 2010

(54) DEVICE FOR CONTROLLING THE VENTILATION APPARATUS FOR A MOTOR VEHICLE INTERIOR

(75) Inventors: Dubravko Barkic, Illingen (DE); Reinhold Weible, Stuttgart (DE); Wolfram Breitling, Sachsenheim (DE); Maximilian Sauer, Konstanz (DE); Michael Arndt, Reutlingen (DE); Dirk Taffe, Stuttgart (DE); Horst Muenzel, Palo Alto, CA (US); Matthias Ludwig, Moessingen (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/596,155

(22) PCT Filed: Feb. 19, 2008
(86) PCT No.: PCT/EP08/51963

§ 371 Date: Nov. 20, 2009

(30) Foreign Application Priority Data
Apr. 18, 2007 (DE) 10 2007 018 571.7

(51) Int. Cl. B60H 1/24; B60H 1/34

(52) U.S. Cl. 454/75; 454/155

(57) ABSTRACT

The invention relates to a device for controlling a ventilation device for a motor vehicle interior (36), comprising at least one air quality sensor (46) for generating an air quality signal of the air supplied to the air quality sensor (46), an actuator for adjusting an air damper (20a, 20b) of the ventilation device as a function of the air quality signal, and a ventilator (14) for transporting the air through the ventilation device into the motor vehicle interior (36). The air quality sensor (46) and the ventilator (14) form a structural unit (44).

### BACKGROUND OF THE INVENTION

The invention relates to a device for controlling the ventilation apparatus for a motor vehicle interior.

DE 197 09 053 A1 discloses a device for controlling ventilation, which device serves to perform close-loop control of the ventilation of an interior as a function of noxious substances. The device comprises an evaluation circuit which processes the signals of an air quality sensor and of a moisture sensor and serves not only to perform closed-loop control of the ventilation as a function of noxious substances but also to automatically reliably prevent windshields from becoming misted up. The air quality sensor is composed of a CO sensor and an NO sensor and it detects the loading of the external air by diesel exhaust gases (NO) and gasoline exhaust gases (CO). If excessive loading occurs, an actuator drive is actuated by means of the evaluation circuit in such a way that an air mixer flap of a ventilation apparatus is closed, with the result that a fresh air operating mode does not take place, but rather only a recirculated air operating mode, in the interior of the motor vehicle. Since this device only detects the quality of the external air, and noxious substances which have already penetrated the interior or were located there before the detection process, can thus no longer be detected, said device is suitable for improving the interior air of the motor vehicle interior only to a limited degree.

EP 1 422 089 A2 presents a method for combating smells and/or noxious substances in the vehicle interior, in which method a ventilation system of the motor vehicle is controlled by means of an air quality sensor in such a way that when smells and/or noxious substances are sensed in the vehicle interior, the air flaps are opened independently of the signal of a further sensor for sensing smells and/or noxious substances in the external air. In this context, for example a CO2 or an infrared gas sensor is used as the air quality sensor for sensing the quality of the interior air. However, alternatives are also sensors on the basis of metal oxide semiconductors or sensors which use piezoelectrically generated surface waves or conductive polymers. Further principles take the form of the quartz microbalance, gas-sensitive MOSFETs, optical sensors or hybrid systems.

EP 1 116 613 A2 discloses using corresponding air quality sensors in conjunction with an HVAC (Heating, Ventilation And Air Conditioning) system for a motor vehicle. The air flaps are controlled here, inter alia, by means of an air conditioning control device as a function of the air quality signals of the air quality sensors. Furthermore, DE 102004051912 A1 discloses implementing recirculated air regulation as a function of requirements in order to minimize the consumption of an air conditioning system. In this context, fresh air is fed into the vehicle interior only when the interior air is actually consumed. This is the case, for example, when the CO2 portion of the interior air exceeds a previously defined concentration level, for example 0.25%. The ventilation flap of the ventilation apparatus of the air conditioning system is then opened until a second concentration level, for example 0.1% (Pettenkofer number), is reached by supplying fresh air. The air flap is then closed again and the air conditioning system can be operated in the energetically most favorable mode.

### SUMMARY OF THE INVENTION

The invention relates to a device for controlling a ventilation apparatus for a motor vehicle interior, having at least one air quality sensor for generating an air quality signal of the air surrounding the air quality sensor, an actuator drive for adjusting an air flap of the ventilation apparatus as a function of the air quality signal and a fan for transporting the air into the motor vehicle interior through the ventilation apparatus. Considerable cost advantages are obtained by virtue of the fact that the air quality sensor and the fan form one structural unit. In addition, a significant reduction in the complexity of the entire system is achieved in a particularly advantageous way since complex cabling of the air quality sensors which were hitherto usually installed under the driver's seat or front passenger's seat in the motor vehicle interior can be avoided.

The air quality sensor is advantageously integrated into the motor electronics of the fan in such a way that it is arranged in the motor vehicle interior outside air ducts of the ventilation apparatus. As a result, the interior air of the motor vehicle interior is supplied to the air quality sensor. Since the exchange of air behind the dashboard of the motor vehicle can be restricted, it is also advantageous if the fan has an additional ventilation opening to the motor vehicle interior, via which additional ventilation opening the air quality sensor is continuously supplied with the interior air. This can be implemented, for example, via a defined leak between the installation space of the air quality sensor in the fan and an air duct of the ventilation apparatus. In order to avoid a flow reversal of the air in the additional ventilation opening of the fan due to ram pressure, said additional ventilation opening is protected by a nonreturn valve.

In one alternative embodiment there is provision that the air quality sensor is integrated into the fan in such a way that said air quality sensor detects the quality of the air conducted within air ducts of the ventilation apparatus. By virtue of the fact that in terms of flow the air quality sensor is, in this case, arranged downstream of the air flap which is embodied as an air mixer flap for setting a defined recirculated air/fresh air ratio, said air quality sensor can monitor directly or indirectly both the interior air and the fresh air conducted from the outside.

Since the motor electronics of the fan serve as common evaluation and control electronics for the integrated air quality sensor and the actuator drive which is electrically connected to the physical unit, advantageous synergy effects are obtained which simplify the electronics and therefore improve their reliability. For this purpose, the structural unit has a common interface by means of which it at least exchanges data with a superordinate control device, in particular an air conditioning system control device, and the actuator drive, and consequently functions as an intelligent subsystem. The exchange of data can take place here via a motor vehicle bus system, for example an LIN bus.

Furthermore, the interface can also serve to supply energy to the structural unit.

In conjunction with an activated air conditioning system, the motor electronics actuate the actuator drive by means of an evaluation and control algorithm stored in it, in such a way that the air quality sensor is always surrounded by a recirculated air portion which is set to the largest possible value as a function of the air quality signal. However, it may alternatively also be advantageous if the air quality sensor is surrounded for a defined time period either exclusively by fresh air or by a recirculated air/fresh air mixture as a function of the air quality signal of the air quality sensor, with the control electronics actuating the actuator drive before and/or after the defined time period in such a way that the air quality sensor is surrounded exclusively by recirculated air. A combination of these two control strategies is also conceivable.

A gas sensor and/or a moisture sensor can be used as the air quality sensor. In this context, a spectroscopic gas sensor, in particular a CO2 sensor, CO sensor or NOx sensor or the like is conceivable as the gas sensor, or a chemical gas sensor is conceivable. In this way it is possible to detect the wide variety of noxious substances or smells in the interior air.

### BRIEF DESCRIPTION OF THE DRAWINGS

The invention is explained by way of example below with reference to FIGS. 1 to 6, with identical reference symbols in the figures indicating identical components with the same method of functioning. The figures in the drawing, their description and the claims contain numerous features in combination. A person skilled in the art will also consider these features individually and combine them to form further appropriate combinations. In particular, a person skilled in the art will also combine the features from different exemplary embodiments to form further appropriate combinations.

In the drawing:

FIG. 1 is a schematic illustration of a known HVAC system in a lateral section through a dashboard of a motor vehicle,

FIG. 2 shows a first and a second exemplary embodiment of a known arrangement of an air flap or of two air flaps for performing open-loop or closed-loop control of a recirculated air/fresh air mixture,

FIG. 3 is a schematic illustration of a first exemplary embodiment of the structural unit according to the invention,

FIG. 4 is a schematic illustration of a second exemplary embodiment of the structural unit according to the invention,

FIG. 5 is a schematic illustration of a third exemplary embodiment of the structural unit according to the invention, and

FIG. 6 is a block diagram of the structural unit according to the invention for actuating an actuator drive which is mechanically connected to an air flap.

### DETAILED DESCRIPTION

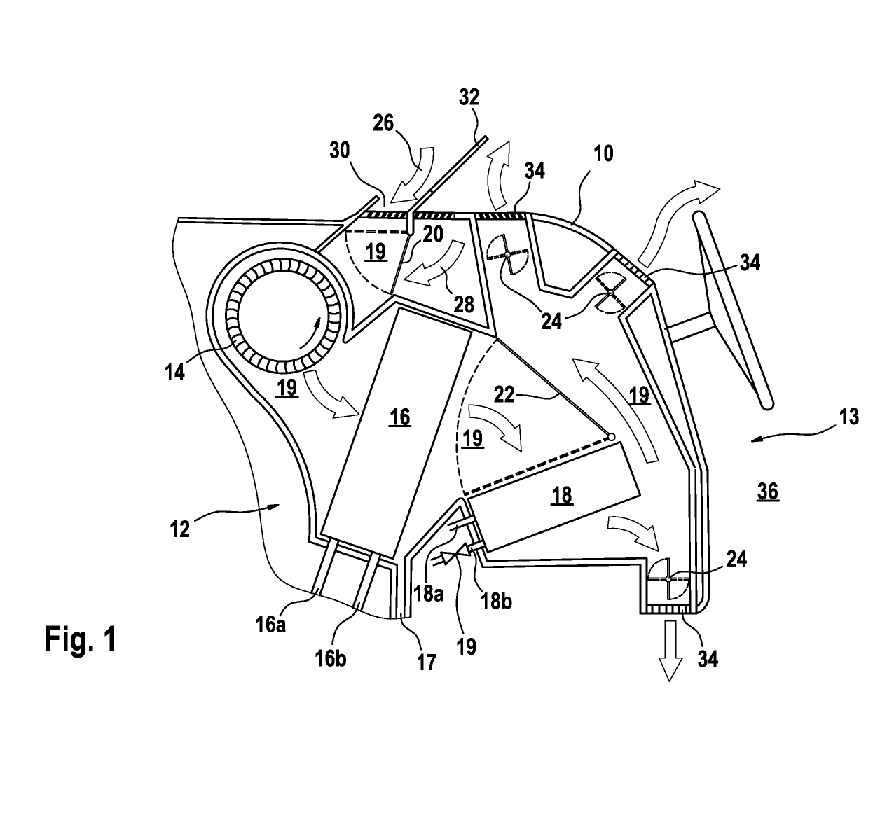

FIG. 1 illustrates a lateral section through a dashboard 10 of a motor vehicle (not shown). It is possible to see an HVAC (Heating, Ventilation and Air Conditioning) system 12, which is known to a person skilled in the art and which has, inter alia, a ventilation apparatus 13 which is composed of a fan 14, a vaporizer 16, a heating element 18, various air ducts 19 and air flaps which are arranged in the air ducts 19 and operate as air mixer flaps 20, 22 and ventilation flaps 24. The path of the fresh air 26 or of the recirculated air 28 through the air ducts 19 of the ventilation apparatus 13 is indicated by means of arrows. Here, the corresponding recirculated air/fresh air mixture can be controlled or regulated by means of the air mixer flap 20. At this point it is to be noted that although a person skilled in the art is familiar with the differences between open-loop and closed-loop control, for the sake of simplicity only the term control will be used below without restricting the invention to this functionality. It therefore goes without saying that the invention also relates to closed-loop control, in particular owing to the air quality sensors which are explained in more detail below.

If the air mixer flap 20 is in the fresh air position (illustrated with a continuous line), the HVAC system 12 is in the fresh air mode. The fresh air 26 which enters the motor vehicle from the outside through a ventilation slit 32 located in front of a windshield 30 is sucked in by the fan 14 and is transported by said fan 14 to the vaporizer 16 which is itself integrated, by means of ports 16a and 16b, into a closed coolant circuit of an air conditioning system (not shown in more detail) of the HVAC system 12. By means of the vaporizer 16 it is possible in a known fashion to cool and/or demoisturize the air flowing through it, wherein the water content which is precipitated at the vaporizer 16 can be carried away via a drainage means 17. Since the method of functioning of an air conditioning system is basically known to a person skilled in the art, more details will not be given on the individual components of the coolant circuit (for example compressor, condenser, expansion element etc.) which are not shown here.

After the fresh air 26 has flowed through the vaporizer 16, it is possible to allow it to flow, by means of a further air mixer flap 22, through the heating element 18, connected via ports 18a and 18b and a hot water check valve 19 to a heating circuit (not illustrated in more detail), for the purpose of heating. In the case illustrated in FIG. 1, the further air mixer flap 22 is in the heating position, which is illustrated by a continuous line. A detailed description of the heating circuit which is connected to the heating element 18 will not be given here because such a heating circuit is generally known to a person skilled in the art. If, in contrast, a pure cooling air mode or fresh air mode is required, the further air mixer flap 22 can be moved into the position indicated by a dashed line, with the result that the fresh air 26 is conducted past the heating element 18. The correspondingly untreated, cooled or heated fresh air 26 then passes by the ventilation flaps 24 through ventilation slits 34 into the motor vehicle interior 36.

If the air mixer flap 20 is moved into the recirculation position illustrated by a dashed line, instead of the fresh air 26 recirculated air 28 is transported through the ventilation apparatus 13 of the HVAC system 12 and the motor vehicle interior 36 by means of the fan 14. This is appropriate in particular when there are noxious substances or unpleasant smells in the external air of the motor vehicle. Furthermore, in the recirculation mode the energy consumption of the air conditioning system can be reduced since the air which is located in the motor vehicle interior 36 and which has already been cooled and demoisturized can be conducted past the vaporizer 16 again and consequently it has a smaller temperature difference with respect to the vaporizer temperature than would be the case with the fresh air 26. In this way, it is possible, in particular when there are high external temperatures, to achieve considerable savings in fuel compared to the fresh air mode.

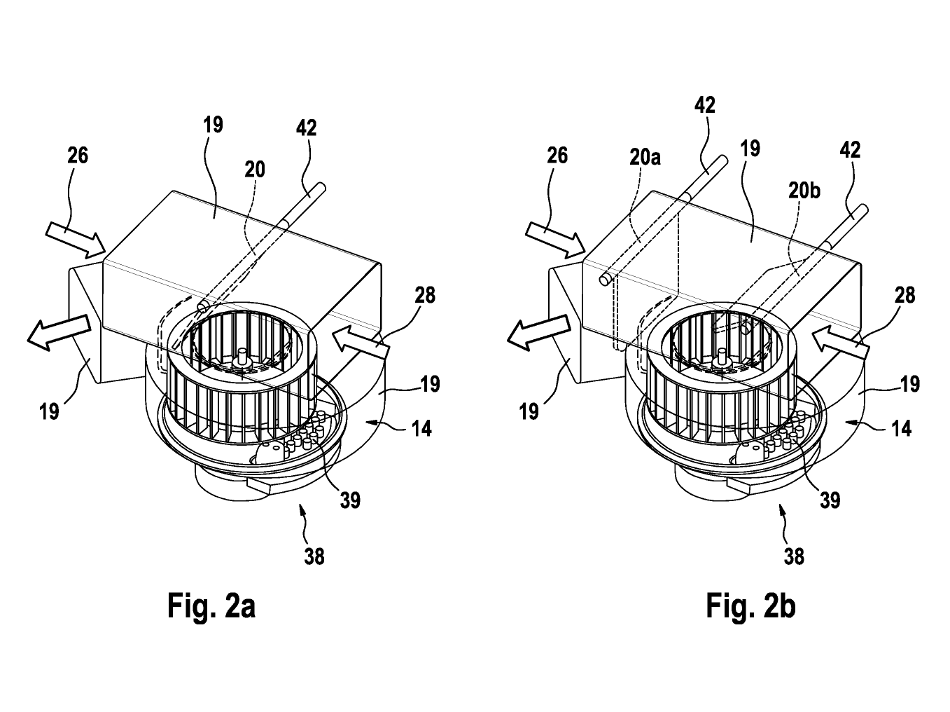

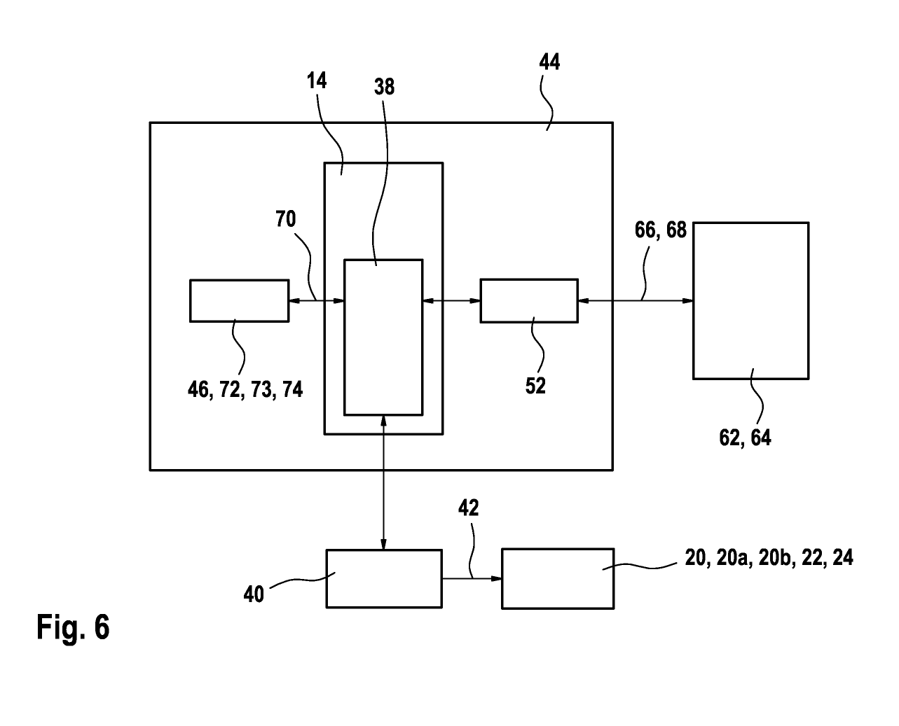

FIG. 2 shows two alternative embodiments according to the prior art for setting a desired recirculated air/fresh air mixture. For this purpose, in FIG. 2a a common air mixer flap 20, which is arranged in the air duct 19, is used in accordance with FIG. 1, which air mixer flap 20 conducts the recirculated air 28 in the illustrated recirculation position (cf. with the dashed line in FIG. 1) to the fan 14, and in the corresponding fresh air position (cf. with the continuous illustrated line in FIG. 1) conducts the fresh air 26 to the fan 14, with the result that said fan 14 transports the resulting air to the vaporizer 16 (see FIG. 1) via a further air duct 19. If the air mixer flap 20 is in a position between the recirculated air position and the fresh air position, a corresponding recirculated air/fresh air mixture is sucked in by the fan 14. The air which is transported by the fan 14 also serves to cool motor electronics 38 which are located underneath a cooling element 39 which can be seen in FIG. 2. FIG. 2b shows a method of functioning which is analogous to that in FIG. 2a, with two air mixer flaps 20a and 20b which are arranged in the air duct 19 and can be actuated separately to bring about the desired recirculated air/fresh air mixture. The air mixer flaps 20, 20a, 20b are each actuated by means of an actuator drive 40 (cf. FIG. 6) which is not shown in FIG. 2 and which can be respectively connected in a rotationally fixed fashion to a pivoting axis 42 of the air mixer flaps 20, 20a, 20b outside the air ducts 19. However, it is alternatively also conceivable for the two air mixer flaps 20a and 20b to be mechanically coupled and actuated by means of a common actuator drive 40.

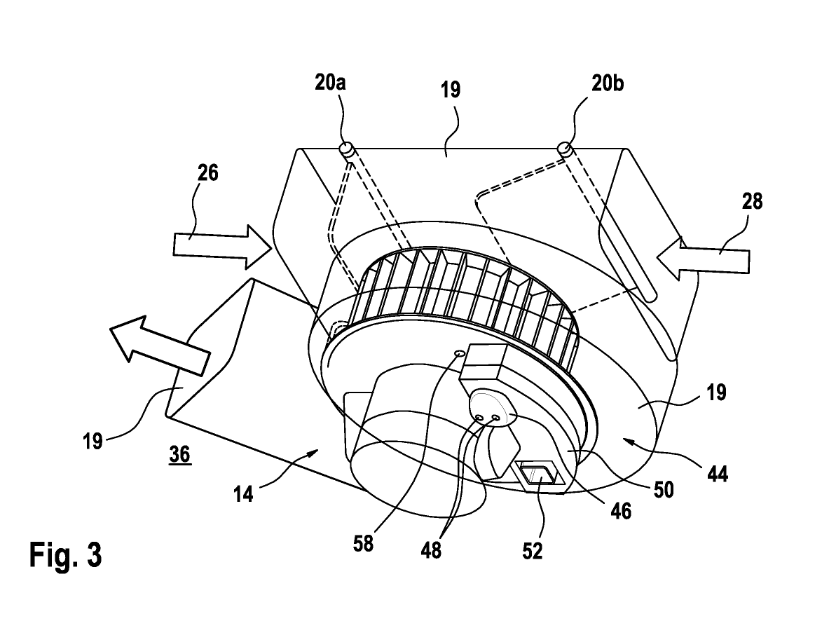

By analogy with FIG. 2b, FIG. 3 shows a first exemplary embodiment of a structural unit 44 according to the invention, which structural unit 44 is composed of the fan 14 and an air quality sensor 46, said air quality sensor 46 being attached to a housing lid 50 of the motor electronics 38. Alternatively it is also possible to integrate the air quality sensor 46 into the housing lid 50, and the latter therefore serves as a common housing for the air quality sensor 46 and the motor electronics 38. The electrical contact between the air quality sensor 46 and the motor electronics 38 for the purpose of exchanging data and supplying energy is made via a corresponding plug-type connection or cable connection (not shown), with the structural unit 44 exchanging data with a superordinate control device 54 (cf. FIG. 6), in particular an air conditioning system control device 56, by means of a common interface 52.

According to FIG. 1, in terms of flow the structural unit 44 is located downstream of the two air mixer flaps 20a and 20b which are arranged in the air duct 19 and with which a desired fresh air/recirculated air mixture, which results from the fresh air 26 and the recirculated air 28, can be set. The air quality sensor 46 is arranged here outside the air ducts 19 in the motor vehicle interior 36, with the result that the interior air is fed to it via corresponding air inlets 48. However, since restricted air circulation can occur behind the dashboard of the motor vehicle due to the design, the fan 14 has, for the purpose of making available a better air supply to the air quality sensor 46, an additional ventilation opening 58 between the installation space of the air quality sensor 46 and the air duct 19 of the ventilation apparatus 13.

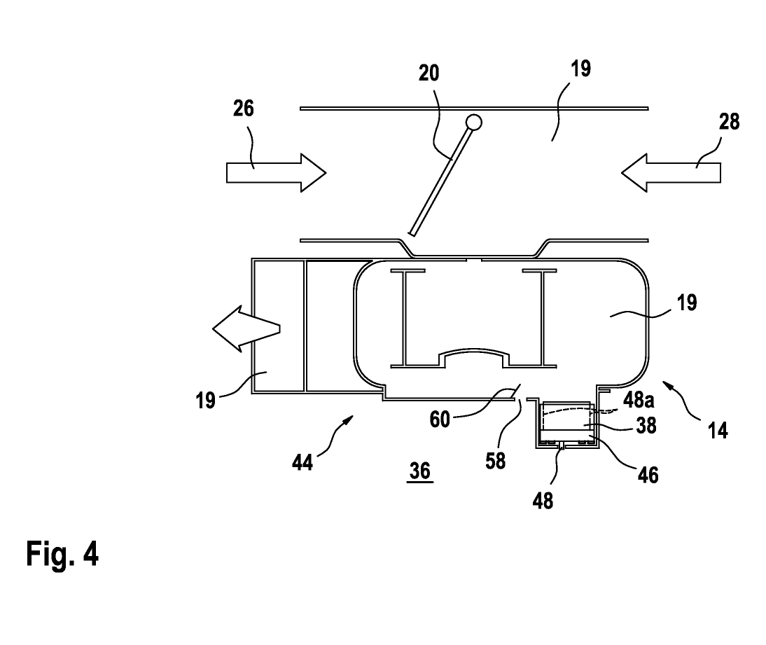

FIG. 4 shows by analogy with FIG. 2a a second exemplary embodiment of the structural unit 44 according to the invention in a lateral section through the fan 14 and the air duct 19 which has the air mixer flap 20. The impeller wheel of the fan 14 is indicated only schematically here. Since the electric motor which drives the impeller wheel is of subordinate importance for the invention, it has not been illustrated either in order to improve clarity. Here, the air quality sensor 46 is arranged under the housing lid 50 of the motor electronics 38, with its air inlet 48 pointing into the motor vehicle interior 36, and the interior air being therefore conducted to it. In this case also, the additional ventilation opening 58 is again provided in order to make available a better air supply to the air quality sensor 46. In order to avoid a flow reversal of the air in the additional ventilation opening 58 due to ram pressure, said additional ventilation opening 58 also has a nonreturn valve 60.

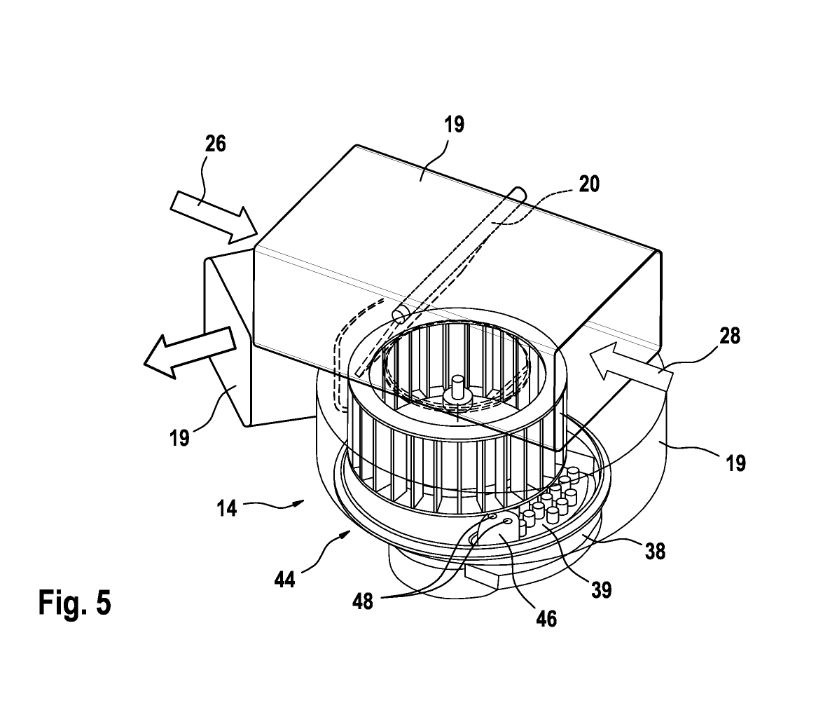

In an alternative embodiment, the air quality sensor 46 is integrated into the fan 14 in such a way that said fan 14 detects the air quality of the air contained within the air ducts 19 of the ventilation apparatus 13. For this purpose, the air quality sensor 46 has air inlets 48a (illustrated by dashed lines in FIG. 4) which permit direct or indirect supply with the recirculated air 28 and/or fresh air 26 in the air duct 19. In this case it is possible to dispense with the air inlets 48 which are directed into the interior, the additional ventilation opening 58 and the nonreturn valve 60. A corresponding exemplary embodiment is shown by FIG. 5 in which the air quality sensor 46 is mounted by its air inlets 48 directed into the air duct 19, but now on the cooling element 39 of the motor electronics 38, which is arranged in the air duct 19.

FIG. 6 shows a block diagram of the structural unit 44 according to the invention. The latter is composed, as already previously explained, of the fan 14, the air quality sensor 46, the motor electronics 38 and the common interface 52. The motor electronics 38 communicate via the common interface 52 with the superordinate control device 64 which is embodied as an air conditioning control device 62. Here, the unidirectional or bidirectional exchange of data takes place via a motor vehicle bus system 66, for example an LIN bus 68, with the result that the structural unit 44 operates as an intelligent subsystem of the HVAC system 12. The motor electronics 38 also receives an air quality signal 70 from the air quality sensor 46 which is a measure of the loading of the interior air or recirculated air 28 and/or the external air or fresh air 26 with noxious substances or smells. The data connection between the motor electronics 38 and the air quality sensor 46 can also be embodied unidirectionally or bidirectionally, and it is therefore possible to calibrate the air quality sensor 46 by means of the motor electronics 38 or to actuate it in some other way. Finally, the motor electronics 38 actuate the actuator drive 40 on the basis of the air quality signal 70 and/or the data received from the superordinate control device 64, which actuator drive 40 is connected in a known, rotationally fixed fashion to the pivoting axis 42 of the corresponding air flap 20, 20a. 20b, 22, 24. The data connection between the motor electronics 38 and the actuator drive 40 may be embodied in a bidirectional fashion in order, for example, to obtain feedback about the current position of the air mixer flap 20.

The motor electronics 38 contain an evaluation and control algorithm on the basis of which, when the air conditioning system is activated, the actuator drive 40 actuates the air mixer flap 20 in such a way that the air quality sensor 46 located in the motor vehicle interior 36 is always surrounded by a recirculated air portion. The motor electronics 38 then set the air mixer flap 20 to the largest possible value for the recirculated air portion as a function of the air quality signal 70, i.e. for example of the CO2 content of the interior air. At the same time, the motor electronics 38 must ensure, for example while taking into account the vehicle speed or the optimum working point of the fan 14 in terms of open-loop and closed-loop control, that a flow reversal in the air duct 19 for the sucking in of recirculated air does not occur due to ram pressure. In one alternative control strategy it is possible to provide that when an air conditioning system is activated the motor electronics 38 actuate the actuator drive 40 in such a way that the air quality sensor 46 has either exclusively a flow of the fresh air 26 or exclusively a flow of a recirculated air/fresh air mixture around it for a defined time period (for example 5 minutes) as a function of the air quality signal 70, with the recirculated air portion being respectively at 100% before and/or after this defined time period. This sequence can be repeated several times at specific intervals as a function of the air quality signal 70. Furthermore it is possible to combine the two described control strategies in a suitable way.

A gas sensor 72, a smell sensor 73 and/or a moisture sensor 74 can be used as an air quality sensor 46. In this way it is possible to detect the wide variety of noxious substances or smells in the interior air. In the case of a gas sensor 72, for example a spectroscopic gas sensor, in particular a CO2 sensor, CO sensor, NOx sensor or the like is conceivable. Alternatively or in combination it is also possible to use a chemical gas sensor, a gas sensor on a metal oxide semiconductor basis, a gas sensor on the basis of a field effect transistor, an optical gas sensor or a gas sensor on the basis of the utilization of surface waves or resonant oscillations, for example of a quartz structure, and the design of such sensors is known to a person skilled in the art and there is no need for further explanation here. The same applies to the smell sensor 73 and the moisture sensor 74, respectively.

In conclusion it is to be noted that the invention is restricted neither to the exemplary embodiment shown according to FIGS. 1 to 6, in particular the spatial configuration of the HVAC system 12 or of the fan 14, nor to the abovementioned values for the defined time period or specific air quality concentrations or recirculated air/fresh air conditions.

1. A device for controlling a ventilation apparatus (13) for a motor vehicle interior (36), having at least one air quality sensor (46) for generating an air quality signal (70) of the air surrounding the air quality sensor (46), an actuator drive (40) for adjusting an air flap (20, 20a, 20b, 22, 24) of the ventilation apparatus (13) as a function of the air quality signal (70) and a fan (14) for transporting the air into the motor vehicle interior (36) through the ventilation apparatus (13), characterized in that the air quality sensor (46) and the fan (14) form one structural unit (44).

2. The device as claimed in claim 1, characterized in that the air quality sensor (46) is integrated into the motor electronics (38) of the fan (14) in such a way that it is arranged in the motor vehicle interior (36) outside air ducts (19) of the ventilation apparatus (13).

3. The device as claimed in claim 1, characterized in that the air supplied to the air quality sensor (46) is the interior air of the motor vehicle interior (36).

4. The device as claimed in claim 3, characterized in that the fan (14) has an additional ventilation opening (58) to the motor vehicle interior (36), via which additional ventilation opening (58) the air quality sensor (46) is continuously supplied with the interior air.

5. The device as claimed in claim 4, characterized in that the additional ventilation opening (58) is protected against a flow reversal by a nonreturn valve (60).

6. The device as claimed in claim 1, characterized in that the air quality sensor (46) is integrated into the fan (14) in such a way that said air quality sensor (46) detects the quality of the air conducted within air ducts (19) of the ventilation apparatus (13).

7. The device as claimed in claim 6, characterized in that in terms of flow the air quality sensor (46) is arranged downstream of the air flap (20, 20a, 20b) which is embodied as an air mixer flap for setting a defined recirculated air/fresh air ratio.

8. The device as claimed in claim 1, characterized in that the structural unit (44) has a common interface (52) by means of which it exchanges data with a superordinate control device (62).

9. The device as claimed in claim 8, characterized in that the exchange of data between the common interface (52) of the structural unit (44) and the superordinate control device (62) takes place via a motor vehicle bus system (66), in particular an LIN bus (68).

10. The device as claimed in claim 1, characterized in that when an air conditioning system is activated, the motor electronics (38) of the fan (14) actuate the actuator drive (40) in such a way that the air quality sensor (46) is always surrounded by a recirculated air portion which is set to the largest possible value as a function of the air quality signal (70).

11. The device as claimed in claim 1, characterized in that when an air conditioning system is activated, the motor electronics (38) of the fan (14) actuate the actuator drive (40) in such a way that the air quality sensor (46) is surrounded for a defined time period either exclusively by fresh air or by a recirculated air/fresh air mixture as a function of the air quality signal (70) of the air quality sensor (46).

12. The device as claimed in claim 11, characterized in that when the air conditioning system is activated, the motor electronics (38) actuate the actuator drive (40) in such a way that the air quality sensor (46) is surrounded exclusively by recirculated air (28) before and/or after the defined time period.

13. The device as claimed in claim 1, characterized in that the air quality sensor (46) is a gas sensor (72), a smell sensor (73) and/or a moisture sensor (74).

14. The device as claimed in claim 13, characterized in that the gas sensor (74) is a spectroscopic gas sensor, in particular a CO₂ sensor, CO sensor, NOx sensor or the like.

15. The device as claimed in claim 13, characterized in that the gas sensor (74) is a chemical gas sensor, a gas sensor on a metal oxide semiconductor basis, a gas sensor on the basis of a field effect transistor, an optical gas sensor or a gas sensor on the basis of the utilization of surface waves or resonant oscillations, for example of a quartz structure.
